(19) United States
(12) Patent Application Publication
(10) Pub. No.: US 2007/0115554 A1
(43) Pub. Date: May 24, 2007

(54) Antireflective surfaces, methods of manufacture thereof and articles comprising the same

(76) Inventors: Eric Michael Breitung, Albany, NY (US); Bastiaan Arie Korevaar, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/285,650

(22) Filed: Nov. 22, 2005

(51) Int. Cl. G02B 1/10

(52) U.S. Cl. 359/586

(57) ABSTRACT

Disclosed herein is an antireflective viewing surface comprising a viewing surface; and a textured layer disposed upon the viewing surface; wherein the textured layer comprises randomly distributed protrusions having randomly distributed dimensions that are smaller than the wavelength of light. Disclosed herein too is a method of manufacturing and antireflective viewing surface comprising electroforming a metal upon a first template to form an electroformed metal template; wherein the first template comprises random, columnar structures; disposing a layer of a polymeric resin on a viewing surface; pressing the electroformed metal template against the viewing surface; and solidifying the polymeric resin.

### BACKGROUND

This disclosure relates to antireflective viewing surfaces, methods for manufacturing the same and articles comprising the same.

Viewing surfaces, such as television screens, computer monitor screens, automotive windshields, store display windows, or the like, generally produce reflections that reduce viewing quality. In order to improve viewing quality, surfaces are often textured. This texturing is uniform in size and distribution and gives rise to an undesirable blue, blue-green or purple haze from the viewing surface.

The manufacture of such textured viewing surfaces, which are antireflective to visible light, are also limited by the size of the area that can be textured. Texturing of a viewing surface is generally conducted by successively texturing small portions of the viewing surface until the entire surface is textured. Methods of manufacturing viewing surfaces are therefore limited by the ratio of the total surface area of the viewing surface to the size of the portions that can be textured at any given time.

It is therefore desirable to rapidly manufacture textured antireflective viewing surfaces having large surface areas. It is also desirable to manufacture antireflective viewing surfaces that do not display a colored haze such as a blue, blue-green, or purple haze.

### SUMMARY

Disclosed herein is an antireflective viewing surface comprising a viewing surface; and a textured layer disposed upon the viewing surface; wherein the textured layer comprises randomly distributed protrusions having randomly distributed dimensions that are smaller than the wavelength of light.

Disclosed herein is a method of manufacturing an antireflective viewing surface comprising electroforming a metal upon a first template to form an electroformed metal template; wherein the first template comprises random, columnar structures; disposing a layer of a formable material on a viewing surface; pressing the electroformed metal template against the viewing surface; and texturing the formable material with the electroformed metal template.

Disclosed herein too is a method of manufacturing an antireflective viewing surface comprising electroforming a metal upon a first template to form an electroformed metal template; wherein the first template comprises random, columnar structures; disposing a layer of a curable resinous material on a viewing surface; pressing the electroformed metal template against the viewing surface; and curing the curable resinous material to form a thermosetting resin.

Disclosed herein too is a method of manufacturing an antireflective viewing surface comprising disposing a layer of a curable resinous material on a viewing surface; pressing a first template against the viewing surface; wherein the first template comprises a metal oxide that has random columnar structures; and curing the curable resinous material to form a thermosetting resin.

Disclosed herein too is a method of manufacturing an antireflective viewing surface comprising heating a viewing surface above its glass transition temperature; wherein the viewing surface comprises a thermoplastic resin; pressing a template against the viewing surface; wherein the template comprises random columnar structures that are smaller than the wavelength of light; and cooling the viewing surface to below its glass transition temperature.

Disclosed herein too are articles comprising the antireflective surface.

### DESCRIPTION OF FIGURES

FIG. 1 a schematic of a first template that comprises random, columnar structures disposed upon a substrate;

FIG. 2 is a scanning electron micrograph that depicts random, columnar structures made from titanium dioxide having pyramidal upper portions;

FIG. 3 is a scanning electron micrograph that depicts the upper surface of the pyramidal upper portions seen in the FIG. 2;

FIG. 4 is a schematic illustration of an exemplary process for manufacturing the antireflective viewing surface;

FIG. 5 is a schematic illustration of an exemplary embodiment for manufacturing the antireflective viewing surface when the electroformed metal template is converted into a cylinder and used as a roll in a roll mill;

FIG. 6 is a scanning electron micrograph of an antireflective viewing surface manufactured from Sample # 6 of Table 2; the thermosetting resin used in this antireflective viewing surface was a polyacrylate;

FIG. 7 is a scanning electron micrograph of an antireflective viewing surface manufactured from Sample # 6 of Table 2; the antireflective viewing surface comprised a textured layer comprising polyurethane that was disposed upon a thermoplastic viewing surface; and

FIG. 8 is a graph showing the loss in reflectivity when a single antireflective viewing surface is utilized instead of a viewing surface that does not have antireflective characteristics.

### DETAILED DESCRIPTION

The terms “first,” “second,” and the like as used herein do not denote any order, quantity, or importance, but rather are used to distinguish one element from another. The terms “a” and “an” do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). As used herein, the term “(meth)acrylate” encompasses both acrylate and methacrylate groups.

Disclosed herein is a method of manufacturing antireflective viewing surfaces wherein the surface comprises random protrusions that have widths of about 25 nanometers (nm) to about 300 nm and heights of about 25 to about 1,000 nm. Disclosed herein is a method of manufacturing an electroformed metal template that is used to manufacture the random protrusions that have widths of about 25 to about 300 nanometers (nm) and heights of about 25 to about 1,000 nm on the antireflective viewing surface. In one embodiment, the electroformed metal template can be used as a mold to texture viewing surfaces thereby converting them to antireflective viewing surfaces. In another advantageous embodiment, the first electroformed metal template can be used to manufacture additional electroformed metal templates that can be used for texturing viewing surfaces to manufacture antireflective viewing surfaces. This method of manufacturing can generate large, stable reusable templates eliminating the need to successively texture small portions of a larger viewing surface until the entire viewing surface is textured. The method advantageously provides a less expensive means to manufacture large antireflective surfaces as compared with methods that employ holographic lithography.

In one embodiment, the method comprises creating a first template from columnar structures manufactured on a substrate. The columnar structures serve as a first template for an electroforming process that is used to manufacture the electroformed metal template. The electroformed metal template is also referred to as the second template. The electroformed metal template comprises a negative image of the columnar features present in the first template. The electroformed metal template is then used to directly manufacture protrusions on a selected viewing surface thereby converting the viewing surface to an antireflective viewing surface. The first template may also be used to directly manufacture protrusions on a selected viewing surface thereby converting the viewing surface to an antireflective viewing surface.

In one embodiment, the first electroformed metal template serves as a parent that is used in an electroforming process wherein additional electroformed metal templates, or daughters, are obtained. In one embodiment, the daughter electroformed metal templates can also be used to directly manufacture protrusions on a selected viewing surface to render the surface antireflective.

The substrate on which the columnar structures are manufactured comprises a material that can withstand the temperatures at which the columnar structures are developed. In one embodiment, it is desirable for the substrate to be thermally and dimensionally stable at temperatures of greater than or equal to about or equal to about 200° C. so that columnar structures can be grown upon the substrate. In another embodiment, it is desirable for the substrate to be thermally and dimensionally stable at temperatures of greater than or equal to about or equal to about 300° C. In another embodiment, it is desirable for the substrate to be thermally and dimensionally stable at temperatures of greater than or equal to about or equal to about 400° C. In another embodiment, it is desirable for the substrate to be thermally and dimensionally stable at temperatures of greater than or equal to about or equal to about 500° C.

The substrate on which the columnar structures are manufactured can have a surface that is flat or curvilinear. It is generally desirable for the substrate to have a surface that is flat, uniform and smooth so that the columnar structures that are manufactured upon the surface do not vary significantly in height. In one embodiment, it is desirable that the substrate have a surface area that is greater than the size of a viewing surface that is to be textured. The substrate on which the columnar structures are manufactured can be cylindrical.

In one embodiment, the substrate can comprise a metal, a ceramic or a combination comprising at least one of the foregoing. Examples of suitable metals are transition metals. Examples of suitable transition metals are titanium, cobalt, aluminum, tin, nickel, iron, copper, zinc, palladium, silver, gold, or the like, or a combination comprising at least one of the foregoing metals. Examples of suitable ceramics are glass, borosilicate glass, quartz, silicon, silicon carbide, silicon nitride, or the like, or a combination comprising at least one of the foregoing ceramics.

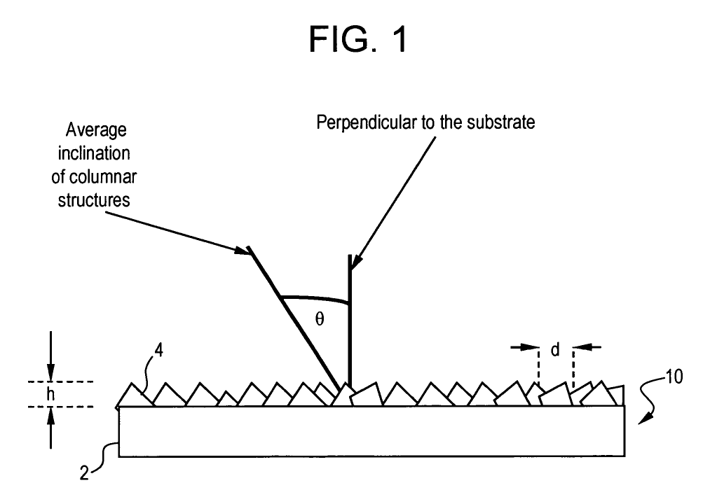

As noted above, the columnar structures are manufactured and disposed on the substrate. FIG. 1 is an exemplary depiction of columnar structures that are manufactured and disposed on the substrate. As can be seen from the FIG. 1, it is desirable to have the columnar structures have their longitudinal axes inclined at an average angle θ of less than or equal to about 45 degrees with a line that is perpendicular to the surface of the substrate. The longitudinal axis is that axis that is parallel to the height of the columnar structures. For example, in the FIG. 1, the longitudinal axis is that axis which is parallel to the height “h” of the columnar structures.

In one embodiment, the columnar structures have their longitudinal axes inclined at an average angle θ of less than or equal to about 25 degrees with a line that is perpendicular to the surface of the substrate. In another embodiment, the columnar structures have their longitudinal axes inclined at an average angle θ of less than or equal to about 10 degrees with a line that is perpendicular to the surface of the substrate. Exemplary columnar structures are those that have their longitudinal axes inclined at an average angle of less than or equal to about 5 degrees with a line that is perpendicular to the surface of the substrate.

The cross-sectional area of each columnar structure can have any geometry such as circular, rectangular, square, or polygonal. The cross-sectional area is measured in a direction that is parallel to the upper surface of the substrate and perpendicular to the direction of growth of the columnar structures. The size of the cross-sectional area is characterized by a width “d” as shown in FIG. 1. The width represents a dimension measured along a side of the columnar structure in a plane that is parallel with the upper surface of the substrate. Thus for example, the width of a columnar structure having a square cross-sectional area would be equal to the side of the square.

In general, the columnar structures have heights and widths that are smaller than the wavelengths of light where the viewing surface is used. It is generally desirable to use columnar structures having heights and widths that are ¼ of the wavelength of light where the viewing surface is used. In one embodiment, the columnar structures have an average height “h” of about 25 to about 1,000 nm and an average width of about 25 to about 300 nm. In another embodiment, the average height can be about 50 to about 500 nm. In yet another embodiment, the average height can be about 75 to about 250 nm. An exemplary average height is about 100 to about 150 nm. In one embodiment, the average width can be about 50 to about 250 nm. In another embodiment, the average width can be about 75 to about 200 nm. An exemplary average width is about 80 to about 100 nm.

The columnar structures have an average aspect ratio greater than or equal to about 2. The aspect ratio as defined herein is the ratio of the length of a particular columnar structure to the smallest width of the columnar structure. In one embodiment, the columnar structures have an average aspect ratio of greater than or equal to about 5. In another embodiment, the columnar structures have an average aspect ratio of greater than or equal to about 10. In yet another embodiment, the columnar structures have an average aspect ratio of greater than or equal to about 100.

Individual columnar structures can contact each other at any point along their heights or can be isolated from other columnar structures. In one embodiment, when the columnar structures are isolated, the space between two nearest columnar structures is greater than or equal to about 5 nm. In another embodiment, the space between two nearest columnar structures is greater than or equal to about 50 nm. In yet another embodiment, the space between two nearest columnar structures is greater than or equal to about 100 nm. In yet another embodiment, the space between two nearest columnar structures is greater than or equal to about 500 nm. The spacing between the columnar structures can be periodic or aperiodic.

In one embodiment, the columnar structures have the same composition as the substrate. In another embodiment, the columnar structures have a composition that is different from that of the substrate. In general, the columnar structures have a different composition from that of the substrate. Examples of compositions of suitable columnar structures that can be manufactured on the aforementioned substrates are titanium dioxide, carbon nanotubes, aluminum borate, aluminum nitride, silicon carbide, hydroxyapatite, zinc oxide, potassium titanate, or the like, or a combination comprising at least one of the foregoing compositions.

In one embodiment, exemplary columnar structures are carbon nanotubes that are manufactured on nickel, cobalt, and/or iron substrates. In another embodiment, exemplary columnar structures are titanium dioxide columns that are manufactured on a substrate that comprises titanium, glass, quartz, or silica.

Carbon nanotubes are generally grown using chemical vapor deposition. When a flat substrate comprising nickel, cobalt and/or iron is subjected to temperatures of about 550 to about 1,200° C. in the presence of a hydrocarbon based gas in a furnace, carbon nanotubes are manufactured on the substrate. The height and width of the substrates can be controlled by the temperature of the furnace as well as by the concentration of the hydrocarbon based gas in the furnace. Single wall carbon nanotubes, multiwall carbon nanotubes, vapor grown carbon fibers, or elongated fullerenes can be used as templates for producing the electroformed metal templates.

In one embodiment, the method of manufacturing titanium dioxide columnar structures comprises utilizing titanium as the substrate. In one embodiment the titanium substrate is oxidized directly by annealing it at a temperature of greater than or equal to about 500° C. In this embodiment, controlled oxidation of the titanium substrate is utilized to manufacture titanium dioxide columnar structures. This method can be used to oxidize flat or curvilinear templates to manufacture the first template. In one advantageous embodiment, direct oxidation of a cylindrical titanium substrate can provide seamless templates for texturing viewing surfaces to manufacture antireflective viewing surfaces.

In another embodiment, the columnar structures are manufactured by utilizing expanding thermal plasma to dispose an amorphous coating on to the substrate. Expanding thermal plasma can be utilized to dispose thin coatings of amorphous material onto a substrate. Exemplary materials that can be disposed utilizing expanding thermal plasma include oxides, nitrides, carbides, amorphous silicon and organic coatings on a substrate. In one embodiment, the method of manufacturing titanium dioxide columns comprises utilizing expanding thermal plasma to dispose an amorphous titanium dioxide coating on to the substrate. The amorphous titanium dioxide coating is annealed at a temperature of greater than or equal to about 500° C. in order to convert the amorphous coating into a poly-crystalline coating comprising columnar structures.

In one embodiment the titanium dioxide coating is annealed at a temperature of about 500° C. for a period of time greater than or equal to about 1 hour. In one embodiment the titanium dioxide coating is annealed at a temperature of about 500° C. for a period of time greater than or equal to about 10 hours. In one embodiment the titanium dioxide coating is annealed at a temperature of about 500° C. for a period of time greater than or equal to about 20 hours. In one embodiment the titanium dioxide coating is annealed at a temperature of about 500° C. for a period of time greater than or equal to about 50 hours.

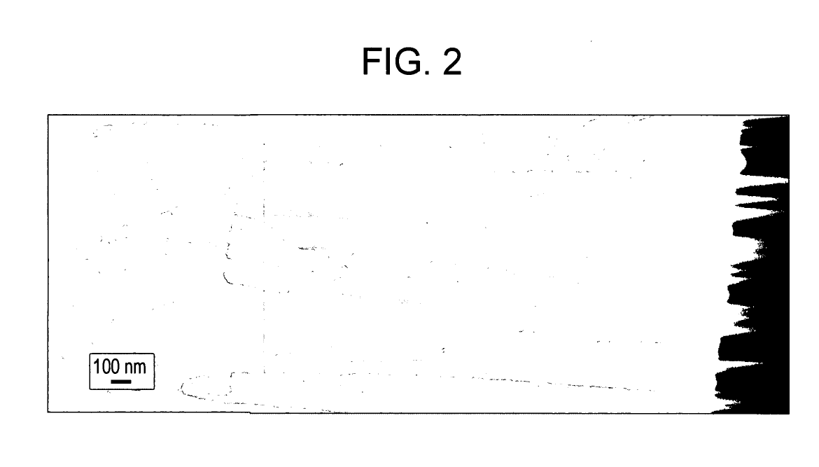

In one embodiment the amorphous titanium dioxide coating is annealed by heating the titanium dioxide coating at a temperature of greater than or equal to about 450° C. for a period of time greater than or equal to about the time effective to convert the amorphous coating to a crystalline material that has columnar structures. In another embodiment the amorphous titanium dioxide coating is annealed by heating the titanium dioxide coating at a temperature of greater than or equal to about 500° C. for a period of time greater than or equal to about the time effective to convert the amorphous coating to a crystalline material that has columnar structures. In one embodiment the amorphous titanium dioxide coating is annealed by heating the titanium dioxide coating at a temperature of greater than or equal to about 600° C. for a period of time greater than or equal to about the time effective to convert the amorphous coating to a crystalline material that has columnar structures. FIG. 2 is a photomicrograph depicting the columnar structures of titanium dioxide.

In one embodiment, the columnar structures can be manufactured by sputtering an amorphous coating on to the substrate. Examples of metals that can be sputtered onto a substrate are aluminum, aluminum alloys, gold, silver, copper, cobalt, chromium, tantalum, titanium, titanium dioxide, nickel, nickel alloys, molybdenum, or the like, or a combination comprising at least one of the foregoing metals. In one embodiment, the titanium dioxide columnar structures can be manufactured by sputtering an amorphous titanium dioxide film on to the substrate and annealing the film.

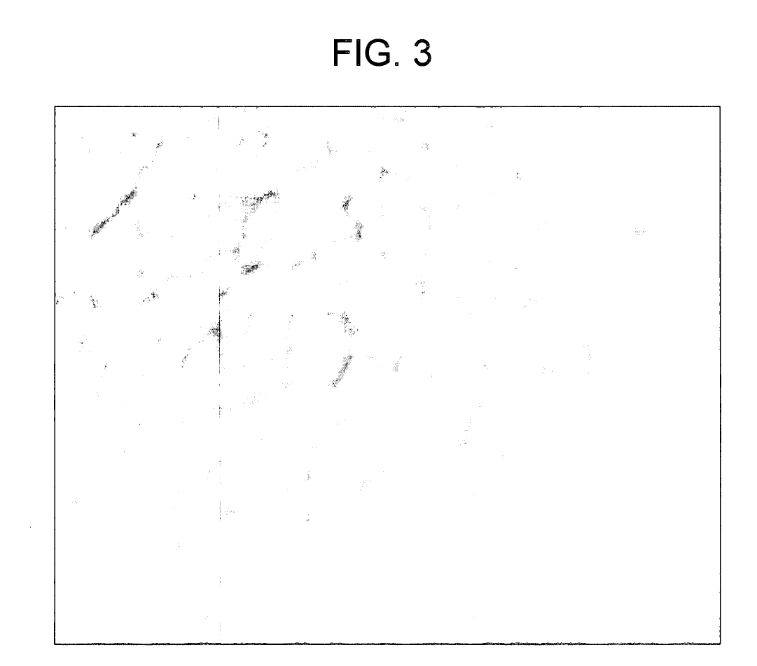

The upper portion of the columnar structures can have various geometries. The upper portion of the columnar structure is that portion that comprises the surface that is opposed to the surface that contacts the substrate. In one embodiment, the upper portion of the columnar structures can be flat, hemispherical, pyramidal, needle shaped, conical, ellipsoidal, or the like. For example, the upper portions of carbon nanotubes are hemispherical, while the upper portions of the titanium dioxide columnar structures are pyramidal. FIG. 3 is a depiction of the upper surface of the upper portions of the titanium dioxide columnar structures. FIG. 3 shows that the upper surface of the upper portions are similar to the upper surface of a pyramid when viewed from above.

The titanium dioxide columnar structures upon annealing can comprise an anatase phase, a brookite phase and/or a rutile phase. As can be seen in the FIGS. 2 and 3, the titanium dioxide columnar structures have pyramidal upper portions. While the columnar structures shown in the FIG. 2 appear to be ordered, the upper portions that comprise the pyramidal structures are random and non-uniform. The use of the random pyramidal portions to manufacture the texturing for the viewing surface causes a reduction in the undesirable colored haze such as a blue, blue-green or purple haze from the viewing surface.

The columnar structures formed by annealing the titanium dioxide generally have a height of about 100 nm to about 150 nm, and a width of about 100 nm to about 150 nm. In one embodiment, the upper portions of the columnar structures can be used as a first template to manufacture the electroformed metal template. In another embodiment, the entire columnar structures can be used as the first template to manufacture the electroformed metal template.

The titanium dioxide comprises a crystalline anatase phase, a brookite phase, a rutile phase, or a combination comprising at least one of the foregoing crystalline phases and has a high surface area of greater than or equal to about 5 square meters per gram (m²/gm). In one embodiment, the surface area of the columnar structure is greater than or equal to about 100 m²/gm. In another embodiment, the surface area of the columnar structure is greater than or equal to about 200 m²/gm. In yet another embodiment, the surface area of the columnar structure is greater than or equal to about 500 m²/gm. In yet another embodiment, the surface area of the columnar structure is greater than or equal to about 1,000 m²/gm.

An electroformed metal template having a negative image of the columnar structures (i.e., the first template) is manufactured in an electroforming process. As noted above, the electroformed metal template is also referred to as the second template. Electroforming is a process wherein electroplating is utilized to dispose metal on the first template. In one embodiment, the electroformed metal template can comprise nickel, silver, gold, copper, cadmium, chromium, magnesium, or the like, or a combination comprising at least one of the foregoing metals. In an exemplary embodiment, electroformed metal template comprises nickel.

The electroformed metal template can comprise an average thickness of about 20 micrometers (μm) to about 5 millimeters (mm). In one embodiment, the electroformed metal template can comprise an average thickness of about 50 μm to about 4 mm. In another embodiment, the electroformed metal template can comprise an average thickness of about 100 μm to about 3 mm. In yet another embodiment, the electroformed metal template can comprise an average thickness of about 500 μm to about 2 mm.

In one embodiment, the method of manufacturing an electroformed metal template comprises placing the first template comprising the columnar structures into a tank comprising a solution that contains the metal that is incorporated into the electroformed metal template. Once the template has been placed into the tank a current is applied to the template and the tank, for a period of time sufficient to generate the electroformed metal template. The positive metallic ions in the solution are attracted to the negatively charged template. The metallic ions are disposed on the template generating the metal template. In one embodiment, the current is applied to the template and the tank for a time period greater than or equal to about 1 hour. In one embodiment, the current is applied to the template and the tank for a time period greater than or equal to about 5 hours. In another embodiment, the current is applied to the template and the tank for a time period greater than or equal to about 15 hours. In yet another embodiment, the current is applied to the template and the tank for a time period greater than or equal to about 30 hours.

Once the electroformed metal template is manufactured, the first template can be removed from the electroformed metal template. The first template can be removed by a variety of methods that include dissolution in a solvent, mechanical abrasion and thermal or chemical degradation. In another embodiment, the first template is removed from the electroformed metal template by using a wedge to separate the material. After the first template has been removed, the resulting electroformed metal template will comprise structures suitable to manufacture the desired antireflective structures on a viewing surface. This resulting electroformed metal template is termed the second template and is also referred to as a master template, parent template or a shim.

In general, the electroformed metal template comprises surface features that are negative images of the surface features of the columnar structures contained in the first template. The electroformed metal template comprises columnar structures having average widths of about 25 to about 300 nanometers (nm) and average heights of about 25 to about 1,000 nm. In one embodiment, the average height of the columnar structures of the electroformed metal template can be about 50 to about 500 nm. In another embodiment, the average height of the columnar structures of electroformed metal template can be about 75 to about 250 nm. An exemplary average height is about 100 to about 250 nm. In another embodiment the average width of the columnar structures of electroformed metal template can about 75 to about 200 nm. An exemplary average width is about 80 to about 100 nm.

The electroformed metal template can comprise columnar structures having an average aspect ratio greater than or equal to about 2. In one embodiment, the columnar structures can have an aspect ratio of greater than or equal to about 5. In another embodiment, the columnar structures can have an aspect ratio of greater than or equal to about 10. In yet another embodiment, the columnar structures can have an aspect ratio of greater than or equal to about 100.

The electroformed metal template is optionally examined for defects and may optionally be subjected to finishing processes. The examination is conducted for quality control purposes and is undertaken to remove surface defects and distortions. The electroformed metal template can be subjected to a finishing operation if desired. The finishing operation may include mechanical or chemical finishing operations such as buffing, lapping, electroplating, electropolishing, or the like, or a combination comprising at least one of the foregoing finishing operations.

As noted above, the electroformed metal template is called a parent template since it can be used to manufacture additional electroformed metal templates that are replicas of the parent template. These replicas are termed daughter templates and can also be used to manufacture the desired antireflective structures on viewing surfaces. The daughter templates are also manufactured by electroforming in a manner similar to that used for manufacturing the parent template. Daughter templates may also be subjected to optional examination for defects and to optional finishing operations.

In one embodiment, the electroformed metal template can be used to generate antireflective structures such as, for example, protrusions on a viewing surface. The viewing surface after the generation of protrusions will hereinafter be referred to as an antireflective viewing surface.

The electroformed metal template comprising random, columnar structures can be used to manufacture antireflective structures on the viewing surface that minimize reflection. In one embodiment, the electroformed metal template can be used to manufacture either a positive image or a negative image of the random, columnar structures (similar to those on the first template) on a selected viewing surface.

The manufacturing of antireflective structures on the viewing surface causes a texturing of the viewing surface. Since the size of the random, columnar structures is about 25 to about 1,000 nanometers, this texturing of the viewing surface produces antireflective properties. In another embodiment, the randomness of the structures on the antireflective viewing surface reduces the blue, blue-green or purple reflective haze associated with textured viewing surfaces that have uniformly sized and uniformly distributed antireflective structures.

The antireflective viewing surface is generally manufactured by disposing a textured layer comprising the random structures upon the viewing surface. The textured layer generally comprises a formable material such as, for example, a polymeric resin. The polymeric resin can be a thermosetting resin, a thermoplastic resin or a combination comprising a thermosetting resin and a thermoplastic resin. The textured layer can also comprise a formable metal or a ceramic. The generation of the textured layer can be accomplished in a batch manufacturing process or in a continuous manufacturing process.

In one embodiment, the textured layer generally comprises a thermosetting resin, while the viewing surface comprises an optically transparent thermoplastic resin. In another embodiment, the textured layer generally comprises a thermosetting resin, while the viewing surface comprises an optically transparent ceramic such as, for example, glass. The ceramic can be optionally coated with a thermoplastic resin or a thermosetting resin for purposes of improving adhesion or abrasion resistance. Thermosetting resins are those that can undergo crosslinking upon heating or upon activation by radiation or by an initiator. In yet another embodiment, a viewing surface comprising a thermoplastic resin can be directly textured using the electroformed metal template. In another embodiment, a thermoplastic film can be textured using the electroformed metal template. The thermoplastic film can then be disposed upon the viewing surface. The viewing surface is then converted into an antireflective viewing surface.

When the textured layer comprises a metal or a ceramic, a metal or a ceramic layer is first disposed on the viewing surface. The electroformed metal template is then used to stamp the metal or the ceramic to manufacture the antireflective viewing surface.

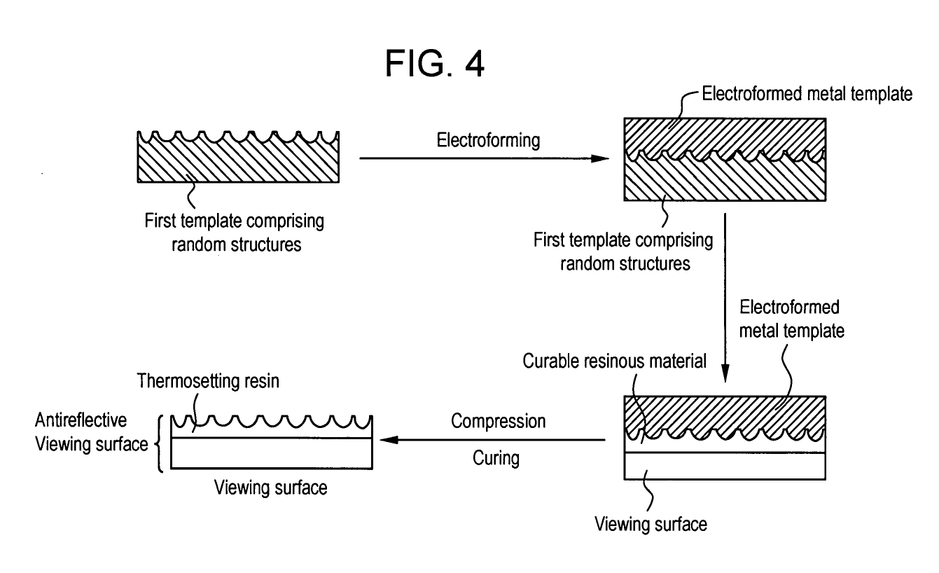

With reference to the FIG. 4, in one embodiment, in one method of manufacturing the antireflective viewing surface, a layer of a curable resinous material is disposed upon the viewing surface. The electroformed metal template is then disposed upon the layer of curable resinous material. The electroformed metal template together with the viewing surface and the layer of curable resinous material disposed therebetween is subjected to compression to remove any excess curable resinous material. The compression of the electroformed metal template against the viewing surface can be accomplished in a press, a roll mill, or the like. After the removal of excess curable resinous material, the curable resinous material is activated to undergo curing. The curable resinous material upon undergoing curing forms a thermosetting resin. After the curing reaction is substantially complete, the electroformed metal template is removed from the antireflective viewing surface. In one embodiment, the curing reaction can be activated by ultraviolet light, microwave radiation, radio frequency radiation, infrared radiation, heat, water, or the like. In an exemplary embodiment, the curing reaction is activated by ultraviolet light.

In another embodiment, the curing reaction can be activated by placing the electroformed metal template, the viewing surface and the curable resinous material disposed therebetween in an oven and raising the temperature of the oven to a value that is greater than that effective to cure the curable resinous material. The curing in the oven is generally carried out after the compression of the electroformed metal template against the viewing surface has occurred. The curable resinous material undergoes curing to form a thermnosetting resin thereby producing a textured layer. The combination of the viewing surface with the textured layer is referred to as the antireflective viewing surface.

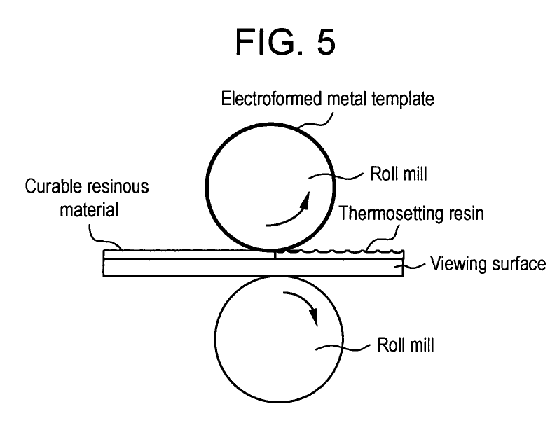

In another embodiment depicted in the FIG. 5, in another method of manufacturing the antireflective viewing surface, the electroformed metal template can be bent into the form of a cylinder. The cylindrical electroformed metal template is then pressed into the curable resinous material (that is disposed on the viewing surface) to manufacture an antireflective viewing surface. The curing of the curable resinous material can begin prior to, during or after the cylindrical electroformed metal template is pressed against the viewing surface. In the embodiment depicted in the FIG. 5, the electroformed metal template can be bent into the form of a cylinder by disposing it on a roll of a roll mill. As the viewing surface with the curable resinous material is passed through the roll mill, the cylindrical electroformed metal template is pressed into the viewing surface to manufacture the antireflective viewing surface.

As noted above, the viewing surface generally comprises a thermoplastic resin. In one embodiment, it is desirable for the thermoplastic resin to be optically transparent. It is desirable for the thermoplastic resin to have a transmission for visible light that exceeds 75%. In another embodiment, it is desirable for the thermoplastic resin to have a transmission that exceeds 85%. In yet another embodiment, it is desirable for the thermoplastic resin to have a transmission that exceeds 90%. Examples of suitable resins are polycarbonate, polyacrylate, polyamide, polyimide, polymethylmethacrylate, polystyrene, styrene acrylonitrile (SAN) resins, cellulose acetate, or the like, or a combination comprising at least one of the foregoing thermoplastic resins. In an exemplary embodiment, the viewing surface comprises polycarbonate.

As noted above, in one embodiment, the viewing surface itself can be fabricated into an antireflective viewing surface. In this embodiment, the electroformed metal templates are pressed against the viewing surface. The temperature of the viewing surface can be raised to around the glass transition temperature of the thermoplastic resin if desired. Upon texturing the viewing surface, the temperature is lowered till the thermoplastic resin solidifies. The electroformed metal template is then removed.

In another embodiment relating to the use of thermoplastic films, a thermoplastic film can be textured by pressing an electroformed metal template against it. The textured film can then be disposed upon a viewing surface and held in position by using an adhesive layer between the textured thermoplastic film and the viewing surface.

The viewing surface can comprise additional layers disposed thereon, such as, for example, a primer layer, an adhesive layer, an abrasion resistant layer, or the like. When the viewing surface comprises an additional layer such as a primer layer or an adhesive layer, the additional layer is generally disposed between the textured layer and the viewing surface.

It is desirable for the curable resinous materials to be cured using electromagnetic radiation to form the thermosetting resin of the textured layer. An exemplary form of electromagnetic radiation is ultraviolet radiation. Examples of curable resinous materials that can be used to form the textured layer are acrylates, methacrylates, epoxies, phenolics, polyurethanes, silicones, or the like, or a combination comprising at least one of the foregoing materials. Exemplary curable resinous materials are acrylates.

Examples of the curable resinous acrylates are monomeric and dimeric acrylates, for example, cyclopentyl methacrylate, cyclohexyl methacrylate, methylcyclohexylmethacrylate, trimethylcyclohexyl methacrylate, norbomylmethacrylate, norbomylmethyl methacrylate, isobomyl methacrylate, lauryl methacrylate 2-ethylhexyl methacrylate, 2-hydroxyethyl methacrylate, hydroxypropyl acrylate, hexanediol acrylate, 2-phenoxyethyl acrylate, 2-hydroxyethyl acrylate, 2-hydoxypropyl acrylate, diethyleneglycol acrylate, hexanediol methacrylate, 2-phenoxyethyl methacrylate, 2-hydroxyethyl methacrylate, 2-hydoxypropyl methacrylate, diethyleneglycol methacrylate, ethylene glycol dimethacrylate, ethylene glycol diacrylate, propylene glycol dimethacrylate, propylene glycol diacrylate, allyl methacrylate, allyl acrylate, butanediol diacrylate, butanediol dimethacrylate, 1,6-hexanediol diacrylate, 1,6-hexanediol dimethacrylate, diethyleneglycol diacrylate, trimethylpropane triacrylate, pentaeryritol tetraacrylate, hexanediol dimethacrylate, diethyleneglycol dimethacrylate, trimethylolpropane triacrylate, trimethylpropane trimethacrylate, pentaeryritol tetramethacrylate, tetrabromobisphenol-A diglycidyl ether diacrylate, phenylthioethyl acrylate or the like, or a combination comprising at least one of the foregoing acrylates

Additionally, the curable resinous material can comprise a polymerization initiator to promote polymerization of the curable components. Exemplary polymerization initiators are those that promote polymerization upon exposure to ultraviolet radiation. Examples of photoinitiators are benzophenone and other acetophenones, benzil, benzaldehyde and o-chlorobenzaldehyde, xanthone, thioxanthone, 2-chlorothioxanthone, 9,10-phenanthrenenquinone, 9,10-anthraquinone, methylbenzoin ether, ethylbenzoin ether, isopropyl benzoin ether, 1-hydroxycyclohexyphenyl ketone, α, α-diethoxyacetophenone, α, α-dimethoxyacetoophenone, 1-phenyl-,1,2-propanediol-2-o-benzoyl oxime, 2,4,6-trimethylbenzoyldiphenyl phosphine oxide, and, α, α-dimethoxy-α-phenylacetopheone, or the like, or a combination comprising at least one of the foregoing photoinitiators.

While it is desirable to manufacture replicas of the random, columnar structures on the viewing surface, this may not always be possible because of the viscosity of the thermosetting resin during the curing reaction. In other words, since the thermosetting resin can still flow during the crosslinking reaction, an exact replica of the electroformed metal template may not always be formed. As a result, the textured layer generally comprises protrusions having dimensions that are less than the wavelength of light. These protrusions have cross-sectional geometries in a direction perpendicular to the viewing surface that can be pyramidal, conical, square, semi-circular, polygonal, ellipsoidal, or a combination comprising at least one of the foregoing geometries.

The average widths of the protrusions is about 25 to about 300 nm and the average height is about 25 to about 1,000 nm. In one embodiment, the average height of the protrusions of the textured layer can be about 50 to about 500 nm. In another embodiment, the average height of the protrusions of the textured layer can be about 75 to about 250 nm. An exemplary average height is about 100 to about 150 nm. In another embodiment the average width of the protrusions of the textured layer can about 75 to about 250 nm. An exemplary average width of the protrusions is about 80 to about 200 nm. In one embodiment, the protrusions can be randomly distributed, i.e., the spacings between the protrusions are aperiodic. The dimensions i.e., the heights and widths of the protrusions are also randomly distributed. In another embodiment, the spacings between the protrusions are periodic.

The protrusions can have aspect ratios that are greater than or equal to about 1. In one embodiment, the protrusions can have aspect ratios that are greater than or equal to about 2. In another embodiment, the protrusions can have aspect ratios that are greater than or equal to about 5. In yet another embodiment, the protrusions can have aspect ratios that are greater than or equal to about 10.

The thickness of the textured layer from the viewing surface can be in an amount of about 25 nanometers to about 50 micrometers. In one embodiment, the thickness of the textured layer from the viewing surface can be in an amount of about 100 to about 20 micrometers. In another embodiment, the thickness of the textured layer from the viewing surface can be in an amount of about 500 nanometers to about 5 micrometers.

As noted above, the antireflective viewing surface can advantageously minimize reflections from a viewing surface. In one embodiment, reflectivity is minimized by an amount of greater than or equal to about 20% from a viewing surface that does not have a textured layer disposed thereon. In another embodiment, reflectivity is minimized by an amount of greater than or equal to about 30% from a viewing surface that does not have a textured layer disposed thereon. In another embodiment, reflectivity is minimized by an amount of greater than or equal to about 50% from a viewing surface that does not have a textured layer disposed thereon. In one embodiment, both sides of the viewing surface (i.e., opposing surfaces) can be textured to form the antireflective viewing surface.

The presence of the textured layer having protrusions disposed on the viewing surface also advantageously reduces the blue, blue-green or purple reflective haze associated with textured viewing surfaces that have uniformly sized and uniformly distributed antireflective structures.

The following examples, which are meant to be exemplary, not limiting, illustrate compositions and methods of manufacturing of some of the various embodiments of the antireflective surfaces described herein.

### EXAMPLES

### Example 1

The following examples demonstrate the deposition of titanium dioxide in an expanding thermal plasma and the subsequent creation of columnar structures having pyramidal upper surfaces. The viewing surfaces (substrates) for these examples were quartz, pyrex glass, and silicon.

Some of the parameters used in the reaction chamber of the expanding thermal plasma during the production of the titanium dioxide layer are shown in Table 1. The pressure in the reaction chamber of the expanded thermal plasma is varied in an amount of 45 to 100 millitorr (mT). Titanium chloride (TiCl₄) was used as the titanium precursor. Argon was fed into an expanding thermal plasma generator at 3 standard liters/minute. Oxygen along with the precursors were fed into the reaction chamber at about 3 centimeters from the anode. The oxygen was fed at a rate of 5 standard liters/minute. TiCl₄ was fed at a rate of 0.2 standard liters/minute. The substrate was preheated and the temperature of the substrate during deposition was about 80° C. The current used to create the plasma arc was 60 amperes. The pressure in the reaction chamber was maintained at 45 mT. As may be seen in the Table 1, one of the samples were subjected to multiple passes in the reaction chamber of the expanding thermal plasma.

TABLE 1

| Sample | Preheat | Dwell Time @ 1000 W (seconds) |
|---|---|---|
| Single pass | 80° C. | 18 |
| Multiple pass | 80° C. | 18 |

The as-deposited materials were amorphous in nature and upon further annealing at a temperature of 500° C., they were converted into the columnar structures with the desired stoichiometry thereby forming crystalline columnar structures comprising anatase. The time for the annealing was 17 hours to 40 hours. The columnar structures obtained upon annealing are generally completely crystalline. In some instances, the columnar structures have a minor portion of an amorphous phase. Table 2 shows data collected from of the different substrates (i.e., silicon glass, pyrex glass and quartz) that were subjected to the same deposition and annealing time. Data shown in Table 2 was obtained using atomic force microscopy. The data for all sample except Sample # 6 was obtained from a measurement of a line scan of a 5 micrometer square scan. Sample # 6 was measured from a 25 micrometer square scan.

TABLE 2

| | | Deposition | Anneal time | | |
|---|---|---|---|---|---|
| Sample | Sub- | time | (hours @ | Width | Height |
| # | strate | (minutes) | 500° C.) | (nm) | (nm) |
| 1 | Silicon | 7 | 17 | 234-1600 | 115-231 |
| 2 | Quartz | 7 | 17 | 712-885 | 320-340 |
| 3 | Silicon | 7 | 40 | 205 | 108-270 |
| 4 | Pyrex | 7 | 40 | 312-585 | 163-358 |
| | Glass | | | | |
| 5 | Silicon | 1 | 40 | 100-200 | 20-59 |
| 6 | Pyrex | 1 | 40 | 250-537 | 63-113 |
| | Glass | | | | |

From Table 2 it may be seen that the substrate can promote differences in the structure of the random, columnar structures obtained. Further, the columnar structures obtained in a first pass can be used as substrates to grow columnar structures having pyramidal upper surfaces in a second pass. The columnar structures grown in a second pass were of a size that could be used for the production of suitable textured surfaces.

### Example 2

This example demonstrates the procedures used for the creation of the electroformed metal template by using a random, columnar structure of TiO₂ as a first template in an electroforming process. In this example, the first template was made by the process described in Example 1 above. The first template used was that of Sample # 6 above. The Sample # 6 was annealed for 40 hours at 500° C. The Sample # 6 contained 1.5 micrometers of TiO₂ on a glass slide. The first template comprising random, columnar structures of TiO₂ was first rinsed using de-ionized water following which its was filled with potassium dichromate solution. The potassium dichromate solution was agitated for about 30 seconds and the solution was drained from the first template. The template was then once again rinsed with de-ionized water.

The first template was then placed in an electroforming tank containing nickel sulfamate solution. The electrodes were connected to the first template and the tank. The current was adjusted to 5 amperes. After 5 minutes, the current was adjusted to 19 amperes. The applied current was proportional to 8 amperes/square foot of cathode. The electroforming was conducted for 12 hours. The electroformed metal template formed on the first template along with any shielding materials are removed from the electroforming tank. The electroformed metal template together with the first template was then once again rinsed in de-ionized water to remove any traces of the electrolytic solution. A portion of the electroformed metal template was then separated from the first template by prying it apart using a screwdriver. After a portion of the electroformed metal template is removed, the remainder was peeled off from the first template.

### Example 3

This example was undertaken to demonstrate the preparation of a textured layer using the electroformed metal template detailed in Example 2. A layer of a curable resin material comprising an acrylate was applied to a polycarbonate-viewing viewing surface to form an antireflective viewing surface. The antireflective coated film was prepared as follows. A template was placed on an aluminum plate and a sheet of polycarbonate film having a thickness of 7 mils with both surfaces polished was placed on top of the template. This stack was placed in an oven and heated to 43° C. After removal from the oven, the polycarbonate film was lifted up, a bead of coating was deposited along one edge of the template, and the film was replaced. The coating comprised a 50/50 mixture by weight of tetrabromobisphenol-A diglycidyl ether diacrylate and phenylthioethyl acrylate, with 0.25 wt. % SILWET 7602® surfactant and 0.5 wt. % IRGACURE 819® photoinitiator. The aluminum plate, template, coating, and film stack was then passed through a nip roll assembly with 20 pounds per square inch (psi) pressure at 40 feet per minute to distribute the coating in an even layer between the template and the polycarbonate film. The template, coating, and film were then passed under a gallium-doped mercury UV lamp operating at 600 watts per inch (W/inch), at a speed of 40 feet per minute to cure the coating. The polycarbonate film and coating were then peeled off the template, establishing the nanotextured viewing surface attached to the polycarbonate film.

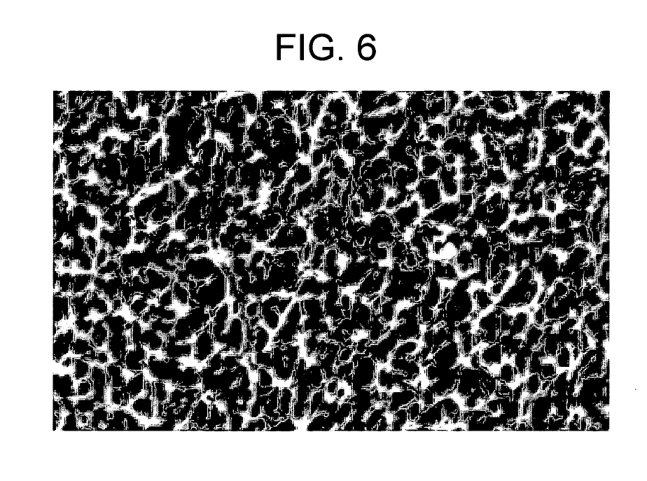

An image of the antireflective viewing surface is depicted in the FIG. 6. FIG. 6 shows that the textured layer (disposed upon the viewing surface) comprises a negative image of the pyramidal columnar structures present in the electroformed metal template.

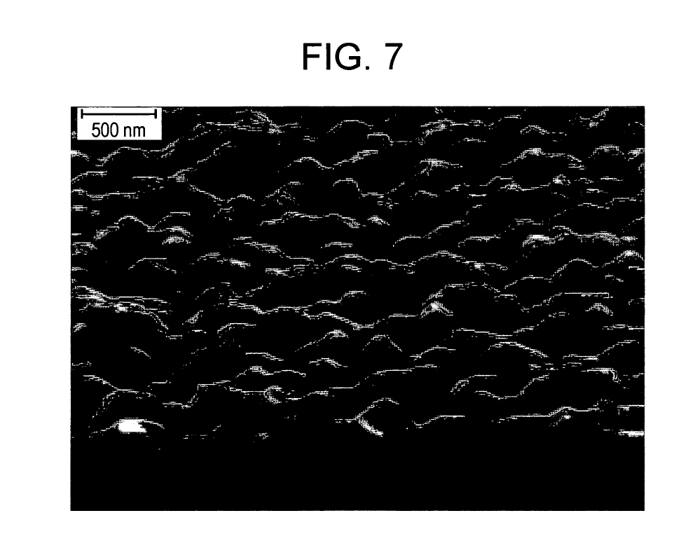

It is to be noted that the electroformed metal template can be copied directly onto a thermoplastic viewing surface. This process is expected to leave a positive image (comprising pyramidal spikes) of the first template in the thermoplastic. FIG. 7 is a photomicrograph taken using scanning electron microscopy that shows a positive image of the electroformed metal template that was formed in polyurethane.

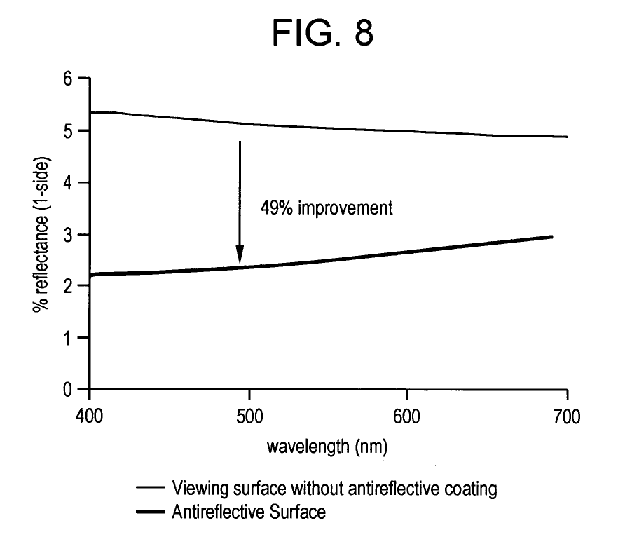

FIG. 8 is a graphical representation that reflects the percentage improvement in viewing quality when an antireflective viewing surface is used to replace a viewing surface that does not have antireflective characteristics. Electroformed metal templates having either the positive image or the negative image of the first template can be used for producing the textured layer on an antireflective viewing surface.

From the above examples, it can be seen that the first template comprising random, columnar structures with pyramidal upper surfaces can be used to manufacture a second template in an electroforming process. The electroformed metal template can then be used to manufacture an antireflective viewing surface comprising a textured layer on a viewing surface. Since the textures are smaller than the wavelength of visible light, they are not visible to the naked eye. In addition, since they are smaller than the wavelength of visible light, they do not reflect light and hence they can be used to manufacture antireflective viewing surfaces.

In one embodiment, reflectivity is minimized by an amount of greater than or equal to about 10% from a viewing surface that does not have a textured layer disposed thereon. In another embodiment, reflectivity is minimized by an amount of greater than or equal to about 40% from a viewing surface that does not have a textured layer disposed thereon. In another embodiment, reflectivity is minimized by an amount of greater than or equal to about 60% from a viewing surface that does not have a textured layer disposed thereon. The presence of the textured layer having random, columnar structures (protrusions) disposed on the viewing surface also advantageously reduces the blue, blue-green or purple reflective haze associated with textured viewing surfaces that have uniformly sized and uniformly distributed antireflective structures.

The present method for producing antireflective surface is advantageous in that it can be used to convert large areas of a viewing surface to antireflective viewing surfaces. In one embodiment, a viewing surface having a surface area greater than or equal to about 10 square centimeters (cm²) can be converted into an antireflective surface in a single operation. In another embodiment, a viewing surface having a surface area greater than or equal to about 25 cm² can be converted into an antireflective surface in a single operation. In yet another embodiment, a viewing surface having a surface area greater than or equal to about 50 cm² can be converted into an antireflective surface in a single operation. In yet another embodiment, a viewing surface having a surface area greater than or equal to about 100 cm² can be converted into an antireflective surface in a single operation. In yet another embodiment, a viewing surface having a surface area greater than or equal to about 500 cm² can be converted into an antireflective surface in a single operation.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An antireflective viewing surface comprising:
a viewing surface; and
a textured layer disposed upon the viewing surface; wherein the textured layer comprises randomly distributed protrusions having randomly distributed dimensions that are smaller than the wavelength of light.

2. The antireflective viewing surface of claim 1, wherein the protrusions have cross-sectional geometries in a direction perpendicular to the viewing surface that is circular, triangular, square, semi-circular, polygonal, ellipsoidal, or a combination comprising at least one of the foregoing geometries.

3. The antireflective viewing surface of claim 1, wherein the protrusions have an average height of about 25 to about 1,000 nanometers and an average width of about 25 to about 300 nanometers.

4. The antireflective viewing surface of claim 1, wherein the protrusions have an average aspect ratio of greater than or equal to about 1.

5. The antireflective viewing surface of claim 1, wherein the viewing surface comprises a thermoplastic resin.

6. The antireflective viewing surface of claim 1, wherein the viewing surface comprises polycarbonate, polyacrylate, polyamide, polyimide, polymethylmethacrylate, polystyrene, styrene acrylonitrile resins, cellulose acetate, or a combination comprising at least one of the foregoing thermoplastic resins.

7. The antireflective viewing surface of claim 1, wherein the textured layer comprises a polymeric resin, and wherein the polymeric resin is a thermosetting resin.

8. The antireflective viewing surface of claim 7, wherein the thermosetting resin is obtained by the reaction of a curable resinous material, and wherein the curable resinous materials are acrylates, methacrylates, epoxies, phenolics, polyurethanes, silicones, or a combination comprising at least one of the foregoing materials.

9. The antireflective viewing surface of claim 7, wherein the textured layer comprises a metal or a ceramic.

10. The antireflective viewing surface of claim 7, wherein the textured layer comprises a thermoplastic resin.

11. The antireflective viewing surface of claim 1, wherein the viewing surface further comprises a textured layer that is disposed on a surface that is opposed to the viewing surface.

12. A method of manufacturing and antireflective viewing surface comprising:
electroforming a metal upon a first template to form an electroformed metal template; wherein the first template comprises random, columnar structures;
disposing a layer of a formable material on a viewing surface;
pressing the electroformed metal template against the viewing surface; and
texturing the formable material with the electroformed metal template.

13. The method of claim 12, wherein the random, columnar structures have upper portions that are pyramidal in shape.

14. The method of claim 12, wherein the electroformed metal template comprises nickel.

15. The method of claim 12, wherein the formable material is a thermosetting resin.

16. The method of claim 12, further comprising curing the formable material.

17. The method of claim 16, wherein the curing is accomplished by irradiating the polymeric resin with ultraviolet light.

18. The method of claim 12, wherein the formable material is a thermoplastic resin.

19. The method of claim 12, wherein the texturing is accomplished in a roll mill.

20. A method of manufacturing an antireflective viewing surface comprising:
electroforming a metal upon a first template to form an electroformed metal template; wherein the first template comprises random, columnar structures;
disposing a layer of a curable resinous material on a viewing surface;
pressing the electroformed metal template against the viewing surface; and
curing the curable resinous material to form a thermosetting resin.

21. The method of claim 20, wherein the random, columnar structures comprise titanium dioxide, carbon nanotubes, aluminum borate whiskers, aluminum nitride whiskers, silicon carbide whiskers, hydroxyapatite, zinc oxide whiskers, potassium titanate, zirconium dioxide needles, or a combination comprising at least one of the foregoing structures.

22. The method of claim 20, further comprising removing the electroformed metal template from the viewing surface.

23. An article comprising the antireflective surface of claim 1.

24. An article manufactured by the method of claim 12.

25. An article manufactured by the method of claim 20.

26. A method of manufacturing an antireflective viewing surface comprising:
disposing a layer of a curable resinous material on a viewing surface;
pressing a first template against the viewing surface; wherein the first template comprises a metal oxide that has random columnar structures; and
curing the curable resinous material to form a thermosetting resin.

27. The method of claim 26, wherein the first template comprises titanium dioxide.

28. An article manufactured by the method of claim 26.

29. A method of manufacturing an antireflective viewing surface comprising:
heating a viewing surface above its glass transition temperature; wherein the viewing surface comprises a thermoplastic resin;
pressing a template against the viewing surface; wherein the template comprises random columnar structures that are smaller than the wavelength of light; and
cooling the viewing surface to below its glass transition temperature.
